(19) United States
(12) Patent Application Publication
(10) Pub. No.: US 2006/0228388 A1
(43) Pub. Date: Oct. 12, 2006

(54) Method for controlling an insect species using a synthetic trail pheromone mimic

(76) Inventor: Terrence D. Fitzgerald, Cortland, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/397,786

(22) Filed: Apr. 4, 2006

Related U.S. Application Data
(60) Provisional application No. 60/669,090, filed on Apr. 7, 2005.

(51) Int. Cl. A01N 25/00

(52) U.S. Cl. 424/405; 514/177

(57) ABSTRACT

The invention provides a method for controlling a caterpillar species using a synthetic trail pheromone mimic.

### CROSS-REFERENCE TO RELATED APPLICATIONS

The present application claims the benefit of co-pending U.S. Provisional Patent Application No. 60/669,090, filed 7 Apr. 2005, which is hereby incorporated herein.

### BACKGROUND OF THE INVENTION

1. Field of the Invention

The present invention relates generally to the control of species of tent caterpillars (Malacosoma spp.) and, more specifically, to the safe, effective, and ecologically-friendly control of caterpillar species using a synthetic trail pheromone mimic.

2. Background of the Invention

Tent caterpillars cause significant losses to forest and shade trees during their episodic outbreaks, but the recent implication of the eastern tent caterpillar (ETC) as a causal agent in Mare Reproductive Loss Syndrome (MRLS) has generated new interest in the development of safe techniques for managing the insect in agriculturally sensitive areas.

The use of chemical insecticides to control insect colonies has long been known. Nearly as long-known, however, are the hazards of insecticide use. For example, not only are many chemical insecticides harmful or fatal to innocuous or beneficial insect species, but may also be harmful or fatal to mammals, birds, and other animals that may come in contact with the insecticide. The danger in using chemical insecticides in close proximity to horses or other animals makes insecticides a very unattractive option for controlling ETC populations.

Biological agents, while generally not as hazardous to non-insect species as chemical insecticides, still suffer from a number of defects. For example, many pest species of Lepidoptera are managed using a formulation of Bacillus thuringiensis, typically B. t. kurstaki. B. thuringiensis has little or no direct effect on mammals, birds, or non-lepidopteran invertebrates. However, formulations of B. thuringiensis specific to a single species have not yet been developed. As a consequence, the use of B. thuringiensis often results in collateral decimation of populations of innocuous caterpillar species. Biological agents, therefore, are potentially just as harmful to some non-target species as chemical insecticides.

Accordingly, there is a need in the art for a method for controlling populations of gregarious insects, such as the ETC and/or other harmful or potentially harmful species of Lepidoptera (e.g., forest tent caterpillars) which both lowers the overall population(s) of the species while specifically preventing them from accessing areas where protection is needed (e.g., forests, orchards, recreational areas, stabling areas, pastures, etc.) that does not suffer from the defects of known methods described above.

Pheromones have been used for the control of certain insect species from as early as 1982. However, such use of pheromones has typically involved the use of sex pheromones. For example, U.S. Pat. No. 4,364,931 describes a method of trapping adult insects as well as disrupting their mating-via air permeation of sex pheromone. Similarly, U.S. Pat. No. 4,498,587 describes a method of preventing Gypsy Moth larvae and other hardwood defoliators from ascending trees and devouring their leaves via spray dispensing of a pheromone around the base of a tree which acts as a barricade. Neither of these patents, utilizes a method by which the communication systems of larval insects is disrupted and insect colonies destroyed.

Accordingly, there is a need in the art for a method for controlling insect species, particularly gregarious caterpillar species, that does not suffer from the defects of known methods.

### SUMMARY OF THE INVENTION

The invention provides a method for controlling caterpillars using a trail pheromone-mimic.

A first aspect of the invention provides a method for controlling a species of Malcosoma, the method comprising: identifying a colony of Malcosoma; and applying to the colony a quantity of a trail pheromone mimic.

A second aspect of the invention provides a method for disrupting communication among members of a colony of a species of Malacosoma, the method comprising: identifying a trail of trail pheromone established by a species of Malacosoma; and masking the trail of trail pheromone with a synthetic trail pheromone mimic.

The illustrative aspects of the present invention are designed to solve the problems herein described and other problems not discussed, which are discoverable by a skilled artisan.

### BRIEF DESCRIPTION OF THE DRAWINGS

FIG. 1 is a schematic representation of the chemical structure of a molecule of 5β-cholestan-3-one, the pheromone-mimic.

### DETAILED DESCRIPTION

Although sex pheromones have been employed for many years in pest management programs, trail pheromones have been thought to have little potential as management tools. Contrary to this notion, studies detailed herein show that trail pheromones or their analogs hold great promise as tools for managing populations of colony-forming, lepidopterous pests. This is the case because the integrated activity of these colonies is essential to their early survival and is wholly dependant on trail-based communication systems. Studies show that these communication systems can be disrupted by spraying infested trees with a synthetic analog of the trail pheromone, masking the caterpillar's authentic pathways and causing colonies to disintegrate and perish. The procedure is feasible because the synthetic pheromone mimic is fully competitive with the authentic pheromone, long-lived, stable under environmental conditions, inexpensive to synthesize in needed quantities, and detected by the caterpillars at extremely low application rates. Moreover, the mimic is highly species-specific, ensuring that it targets only the intended pest organisms.

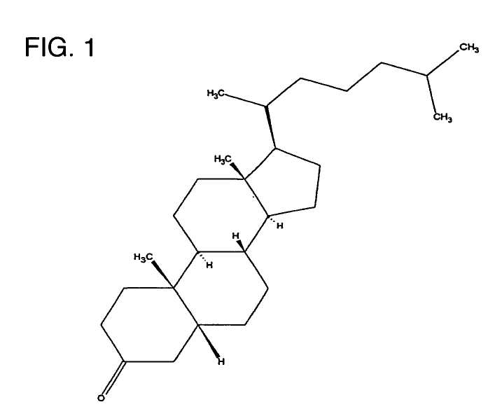

FIG. 1 shows the structure of a 5β-cholestan-3-one. Analogs, isomers, metabolites, derivatives, and pro-pheromones of the compounds of FIG. 1 are within the scope of the present invention, as are compounds chemically- or pharmacologically-related to or adapted from the compounds of FIG. 1.

In one embodiment of a method according to the invention, a synthetic analog of the trail pheromone of the tent caterpillar, 5β-cholestan-3-one, is sprayed on caterpillar-infested trees. Studies and experiments with the eastern tent caterpillar show that the compound is fully competitive with the authentic trail of the insect and that the caterpillars cannot distinguish their trails from the background levels of the pheromone mimic. When sprayed on trees, newly emerged caterpillars moved onto the treated pathways independently of each other, became widely separated, fail to form a communal tent, and are prevented from engaging in a suite of pheromone-mediated, cooperative foraging behaviors that are critical to their early survival. Disruption of their trail-based communication system leads to the disintegration and complete collapse of colonies.

As will be described in greater detail below, spraying the surfaces of caterpillar-infested trees with a synthetic analog of their trail pheromone effectively masks the caterpillars' authentic pathways, causing the caterpillars to disassociate and their colonies to disintegrate and perish.

As indicated above, the invention provides a method for controlling species of caterpillars in the genus Malacosoma using a trail pheromone mimic. While not previously used in the management of an insect species, trail pheromones are essential to the development and survival of colony-forming insects. The formation and survival of colonies of such insects is wholly-dependent upon trail-based communication among colony members. Gregarious caterpillars, such as tent caterpillars (Malacosoma spp.), cooperate in foraging, shelter building, thermoregulation, and predator defense. Studies show that the early instars of these caterpillars suffer markedly when separated from the aggregate and perish due to the loss of these cooperative benefits.

A primary object of the present invention is to provide a method for controlling a species, such as the Eastern tent caterpillar (Malacosoma americanum) (ETC), the forest tent caterpillar (Malacosoma disstria) (FTC), and/or related species, through the use of the trail pheromone mimic.

Background Studies

The threshold sensitivity of tent caterpillars to 5β-cholestan-3-one laid out in a narrow line on a paper card was determined to be approximately 10⁻¹¹ g/mm. Field tests were conducted by using the compound to form artificial trails that intersected well established, authentic trunk trails of colonies of 3^{rd}-5^{th} instar ETCs. In 19 of 23 replicates of these tests, each involving a different colony, colonies abandoned their authentic trail systems and followed the pathways marked with 5β-cholestan-3-one. Moreover, the compound was shown to be fully competitive with authentic recruitment trails of the caterpillar. Other studies indicate that the authentic trail pheromone of the tent caterpillar (Malacosoma spp.) may differ subtly from 5β-cholestan-3-one. Thus, 5β-cholestan-3-one is best considered an analog, or pheromone mimic of the authentic tent caterpillar pheromone.

Experiments conducted to disrupt colonies by blanket spraying the pheromone-mimic under field conditions showed that colonies of caterpillars occurring on trees treated with the pheromone-mimic were largely destroyed. Three experiments were conducted, all employing the following protocol. Trees in the experimental plot were divided into two groups. Trees in one group were sprayed with a 1 part per million (ppm) pheromone-mimic formulation and trees in another group were sprayed with a control solution identical to the pheromone mimic formulation except that it lacked the pheromone-mimic. Egg masses were attached to each tree and the fate of the colonies determined by observation.

In the first experiment, involving eastern tent caterpillars on cherry trees, all of ten control colonies survived and thrived while seven of ten treated colonies were completely destroyed within several days and the three remaining colonies eventually died out as well. In the second experiment, ten control colonies of the eastern tent caterpillar on apple trees survived and thrived while all of ten colonies on treated trees were destroyed within one week. In the third experiment, all fifteen colonies of the forest tent caterpillar on ash trees survived and thrived while all of fifteen colonies on treated trees perished within one week. While the exact fate of caterpillars on the treated trees is unknown, they most likely succumbed to a combination of weather related factors, starvation, predation, and falls from the trees.

Solutions of pheromones suitable for use in practicing the present invention may be prepared by any number of methods, as will be recognized by one skilled in the art. For example, a suitable pheromone solution of 5β-cholestan-3-one may be prepared as follows:

1. Dissolve a quantity of 5β-cholestan-3-one in absolute ethanol; and

2. Dilute the solution with distilled water to yield a 10a% ethanol colloidal dispersion.

Optionally, the solution above may be combined with a spreader-sticker to enhance the dispersal of the trail pheromone mimic.

The method above provides a solution containing 1 part per million (ppm) of 5β-cholestan-3-one. A solution of this strength has proved effective in disrupting the communicative system of the ETC.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for controlling a species of Malcosoma, the method comprising:
identifying a colony of Malcosoma; and
applying to the colony a quantity of a trail pheromone mimic.

2. The method of claim 1, wherein the species of Malcosoma includes at least one of the following: M. americanum and M. disstria.

3. The method of claim 1, wherein the trail pheromone mimic includes 5β-cholestan-3-one.

4. The method of claim 3, wherein the trail pheromone mimic is in the form of a 10% ethanol colloidal dispersion.

5. The method of claim 4, wherein the 10% ethanol colloidal dispersion further includes a spreader-sticker for enhancing the dispersal of the trail pheromone mimic.

6. The method of claim 4, wherein the 10% ethanol colloidal dispersion includes 5β-cholestan-3-one at a concentration of about 1 part per million.

7. The method of claim 1, wherein applying includes blanket spraying of the colony.

8. The method of claim 1, wherein identifying includes identifying at least one tree containing a colony of Malcosoma.

9. The method of claim 1, wherein the trail pheromone mimic is capable of disrupting in the species of Malcosoma at least one of the following: communal tent formation, cooperative foraging, thermoregulation, and predator defense.

10. A method for disrupting communication among members of a colony of a species of Malacosoma, the method comprising:
identifying a trail of trail pheromone established by a species of Malacosoma; and
masking the trail of trail pheromone with a synthetic trail pheromone mimic.

11. The method of claim 10, wherein the species of Malcosoma includes at least one of the following: M. americahum and M. disstria.

12. The method of claim 10, wherein the trail pheromone mimic includes 5β-cholestan-3-one.

13. The method of claim 12, wherein the trail pheromone mimic is in the form of a 10% ethanol colloidal dispersion.

14. The method of claim 13, wherein the 10% ethanol colloidal dispersion further includes a spreader-sticker for enhancing the dispersal of the trail pheromone mimic.

15. The method of claim 13, wherein the 10% ethanol colloidal dispersion includes 5β-cholestan-3-one at a concentration of about 1 part per million.

16. The method of claim 10, wherein the trail pheromone mimic is capable of disrupting in the species of Malcosoma at least one of the following: communal tent formation, cooperative foraging, thermoregulation, and predator defense.
